(19) United States
(12) Patent Application Publication
(10) Pub. No.: US 2024/0411383 A1
(43) Pub. Date: Dec. 12, 2024

(54) STRUCTURAL COLOR DRAWING DEVICE, STRUCTURAL COLOR DRAWING SYSTEM, STRUCTURAL COLOR DRAWING METHOD, AND STORAGE MEDIUM STORING STRUCTURAL COLOR DRAWING PROGRAM

(71) Applicant: Mitsubishi Electric Corporation, Tokyo (JP)

(72) Inventors: Shohei SHINTA, Tokyo (JP); Takuya MAEKAWA, Tokyo (JP); Makoto OTSURU, Tokyo (JP)

(73) Assignee: Mitsubishi Electric Corporation, Tokyo (JP)

(21) Appl. No.: 18/812,586

(22) Filed: Aug. 22, 2024

Related U.S. Application Data
(63) Continuation of application No. PCT/JP2022/016734, filed on Mar. 31, 2022.

(51) Int. Cl. G06F 3/03; G06F 3/042

(52) U.S. Cl. CPC G06F 3/0321; G06F 3/0425

(57) ABSTRACT

A structural color drawing device includes a surface information acquisition unit, an information mapping unit, an optical path difference calculation unit to calculate an optical path difference, an import unit to import a reference table storing values of a second term of a calculation formula of a stimulus value in an XYZ color model having a first term independent of the optical path difference and the second term dependent on the optical path difference while associating the values with the optical path differences, a stimulus value calculation unit to acquire values corresponding to the optical path difference calculation values from the reference table and to calculate three stimulus values in the XYZ color model by using the calculation formula and the values, and an RGB conversion unit to convert the three stimulus values to RGB values.

### CROSS-REFERENCE TO RELATED APPLICATION

This application is a continuation application of International Application No. PCT/JP2022/016734 having an international filing date of Mar. 31, 2022.

### BACKGROUND OF THE INVENTION

### 1. Field of the Invention

The present disclosure relates to a structural color drawing device, a structural color drawing system, a structural color drawing method and a structural color drawing program.

### 2. Description of the Related Art

There has been proposed a method that realizes real-time structural color rendering by expressing structural color occurring due to an optical phenomenon caused by microscopic structure smaller than or equal to the wavelength of light by texture expression by using computer graphics (CG) (see Non-patent References 1 and 2, for example). In the method proposed by the Non-patent References 1 and 2, the surface of an object is regarded as a diffraction grating having uneven structure and the structural color rendering is performed based on optical path differences calculated from an incidence angle and a reflection angle of light.

Non-patent Reference 1: Masahiko Saeki and four others, “Rendering of Structural Color Using Texture Expression of Optical Path differences”, IPSJ SIG Technical Report, pages 85-90, Nov. 19, 2005.

Non-patent Reference 2: Masahiko Saeki, Master's Thesis, “Generic Rendering Method of Structural Color Objects”, Nara Institute of Science and Technology, Graduate School of Information Science, Information Processing Department, NAIST-IS-MT0451061, Feb. 2, 2006.

However, on a processing surface or the like of an actual object, repeated uneven structure is not uniform and there is variation in the height of a convex part, and thus the optical path difference is dependent not only on the incidence angle and the reflection angle of light but also on other information. Therefore, the conventional method has a problem in that the accuracy of reproduction of the structural color (i.e., drawing of the structural color) by the structural color rendering is low.

### SUMMARY OF THE INVENTION

An object of the present disclosure is to increase the accuracy of the drawing of the structural color on the surface of an object.

A structural color drawing device in the present disclosure is a device that reproduces structural color of an object. The structural color drawing device includes processing circuitry to acquire surface information, including height differences of a plurality of peaks in uneven structure on a surface of the object and interval distances between adjacent peaks among the plurality of peaks, from a captured image obtained by a camera or measurement information obtained by a measuring instrument; to map the surface information on a drawing object corresponding to the object; to calculate an optical path difference at each position on the drawing object by using the mapped surface information and to output optical path difference calculation values; to import a reference table storing values of a second term of a calculation formula of a stimulus value in an XYZ color model having a first term independent of the optical path difference and the second term dependent on the optical path difference while associating the values with the optical path differences; to acquire values corresponding to the optical path difference calculation values from the imported reference table and to calculate three stimulus values in the XYZ color model by using the calculation formula and the values; and to convert the three stimulus values to RGB values.

A structural color drawing method in the present disclosure is a method to be executed by a structural color drawing device that reproduces structural color of an object. The structural color drawing method includes acquiring surface information, including height differences of a plurality of peaks in uneven structure on a surface of the object and interval distances between adjacent peaks among the plurality of peaks, from a captured image obtained by a camera or measurement information obtained by a measuring instrument, mapping the surface information on a drawing object corresponding to the object, calculating an optical path difference at each position on the drawing object by using the mapped surface information and outputting optical path difference calculation values, importing a reference table storing values of a second term of a calculation formula of a stimulus value in an XYZ color model having a first term independent of the optical path difference and the second term dependent on the optical path difference while associating the values with the optical path differences, acquiring values corresponding to the optical path difference calculation values from the imported reference table and calculating three stimulus values in the XYZ color model by using the calculation formula and the values, and converting the three stimulus values to RGB values.

According to the present disclosure, the accuracy of the drawing of the structural color on the surface of an object can be increased.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram for explaining calculation of an optical path difference between a plurality of incident rays on a reflective diffraction grating, an optical path difference between a plurality of reflected rays reflected by the reflective diffraction grating, and a total optical path difference as the sum total of the optical path difference between the incident rays and the optical path difference between the reflected rays;

FIG. 2 is a schematic cross-sectional view magnifying the reflective diffraction grating in FIG. 1;

FIG. 3 is a diagram showing an example of a color structure texture as a color storage table;

FIG. 4A is a schematic perspective view showing an example of an object, FIG. 4B is a diagram showing a cross-sectional shape of the object in FIG. 4A, and FIG. 4C is a schematic diagram showing a part D of the object in FIGS. 4A and 4B;

FIG. 5 is a schematic cross-sectional view magnifying the reflective diffraction grating on a surface of the object;

FIG. 6 is a diagram showing an example of the color storage table;

FIG. 7 is a functional block diagram showing the configuration of a structural color drawing device and a structural color drawing system according to an embodiment;

FIG. 8 is a flowchart showing a drawing operation executed by the structural color drawing device according to the embodiment;

FIG. 9 is a diagram showing an example of the hardware configuration of the structural color drawing device and the structural color drawing system according to the embodiment; and

FIG. 10 is a flowchart showing a resolution determination process in the structural color drawing device according to the embodiment.

### DETAILED DESCRIPTION OF THE INVENTION

A structural color drawing device, a structural color drawing system, a structural color drawing method and a structural color drawing program according to an embodiment will be described below with reference to the drawings. The following embodiment is just an example and appropriate modifications are possible within the scope of the present disclosure.

A structural color drawing system according to the embodiment includes an input device (e.g., camera, measuring instrument or the like) as a device for photographing microscopic structure (or structural color caused by the microscopic structure) on a surface of an object such as a processing surface of the object, a structural color drawing device that generates a reproduction image, expressing the structural color based on a camera image or measurement information by texture expression, by means of real-time structural color rendering by using CG, and a display device that displays the reproduction image.

The structural color drawing device according to the embodiment is, for example, a computer that executes a structural color drawing program. The structural color drawing device is a device that reproduces an image of a rainbow pattern caused by the uneven structure (i.e., reflective diffraction grating) on the surface of the object by using CG.

A structural color drawing method according to the embodiment is a method to be executed by a computer, for example. The structural color drawing is referred to also as structural color rendering or texture mapping.

### Comparative Example

First, a structural color drawing method in a comparative example will be described below. In the comparative example, a description will be given of a case where the height of the peak of a convex part in the uneven structure on the surface of the object is uniform. In general, the following expressions (1) to (3) are used for calculating color information:

$$X = \frac{100}{{\int }_{380}^{780} R ( λ ) y ( λ ) d λ} {\int }_{380}^{780} R ( λ ) I ( λ ) x ( λ ) d λ . \qquad ( 1 )$$

$$Y = \frac{100}{{\int }_{380}^{780} R ( λ ) y ( λ ) d λ} {\int }_{380}^{780} R ( λ ) I ( λ ) y ( λ ) d λ . \qquad ( 2 )$$

$$Z = \frac{100}{{\int }_{380}^{780} R ( λ ) y ( λ ) d λ} {\int }_{380}^{780} R ( λ ) I ( λ ) z ( λ ) d λ . \qquad ( 3 )$$

Here, λ represents the wavelength of light and R(λ) represents spectral distribution of a light source. Further, x(λ), y(λ) and z(λ) represent color matching functions in the XYZ color model. I(λ) represents intensity of an interference wave, which is calculated according to the following expression (4). The values 380 nm and 780 nm represent a wavelength range of a definite integral.

$$I ( λ ) = {\sum }_{i = 1}^{n} {A}_{i}^{2} + {\sum }_{i = 1}^{n} {\sum }_{j = i + 1}^{n} 2 {A}_{i} {A}_{j} cos ( {δ}_{i} - {δ}_{j} ) . \qquad ( 4 )$$

$${δ}_{i} = \frac{2 π}{λ} {Δ}_{i} , {δ}_{j} = \frac{2 π}{λ} {Δ}_{j} .$$

In the expression (4), A (i.e., Aᵢ, Aⱼ) represents amplitude. The character n represents the number (i.e., integer greater than or equal to 2) of interfering waves, i represents an integer from 1 to n, and j represents an integer from i+1 to n. Further, each of Δᵢ and Δⱼ represents an optical path difference. Furthermore, a conversion formula between the three stimulus values (X, Y, Z) in the XYZ color model and the (R, G, B) values in the RGB color model is generally represented by the following expression (5). The expression (5) is shown in the Non-patent Reference 1, for example.

$$[ \begin{matrix}R \\ G \\ B\end{matrix} ] = [ \begin{matrix}3.240479 & - 1.53715 & - 0.498535 \\ - 0.969256 & 1.875992 & 0.041556 \\ 0.055648 & - 0.204043 & 1.057311\end{matrix} ] [ \begin{matrix}X \\ Y \\ Z\end{matrix} ] . \qquad ( 5 )$$

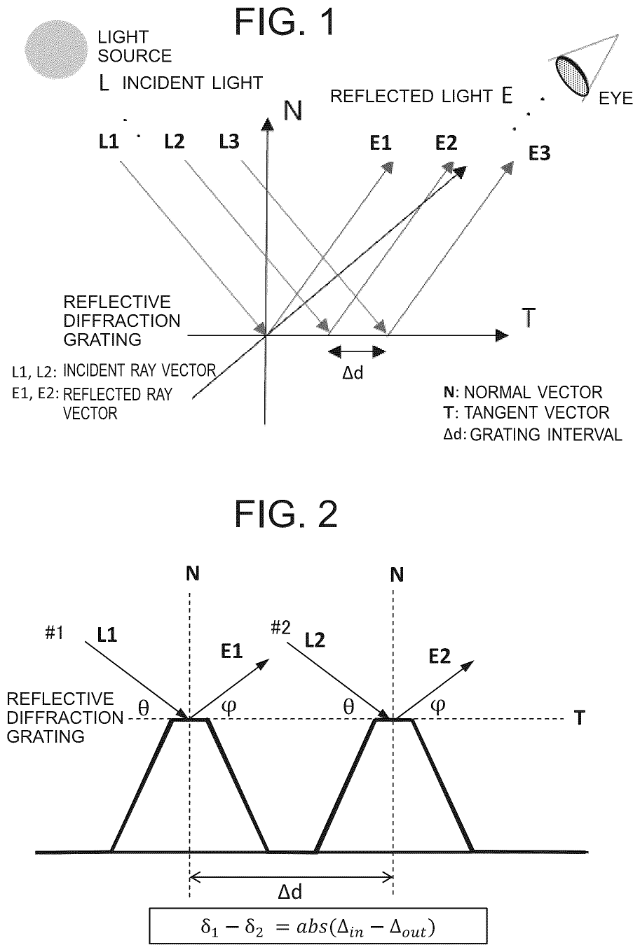

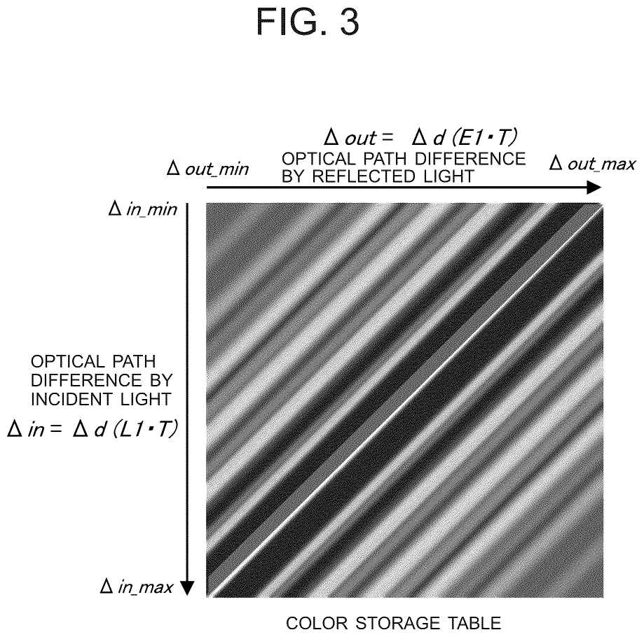

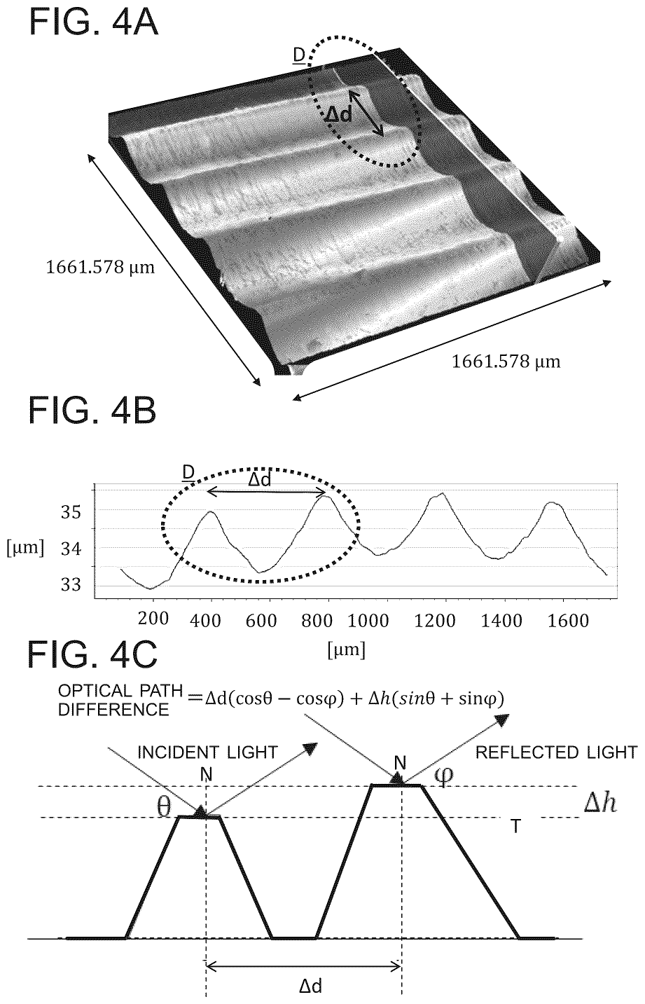

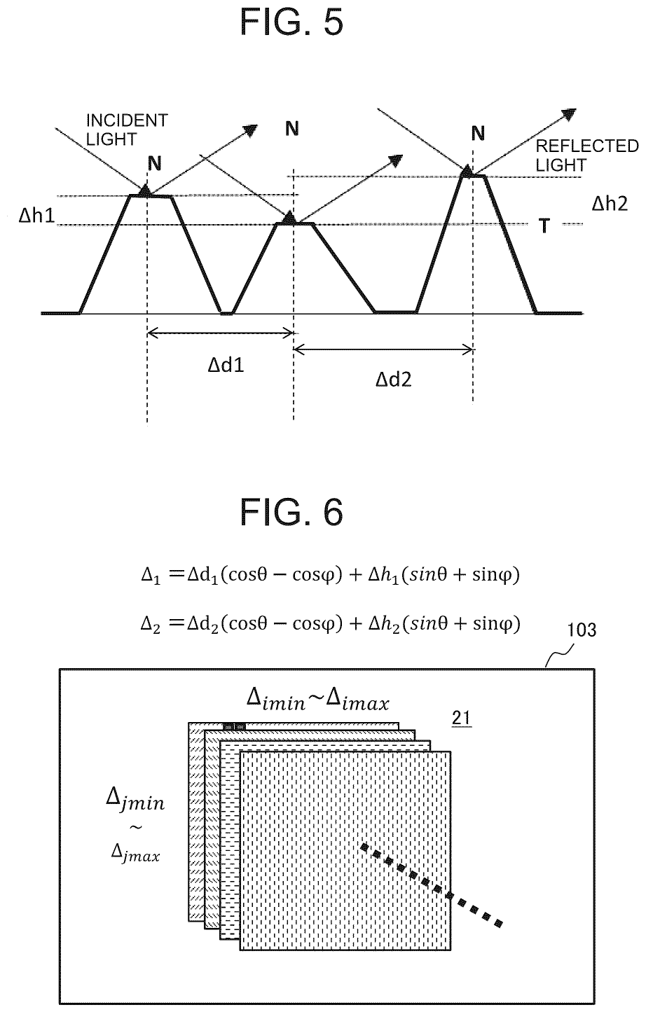

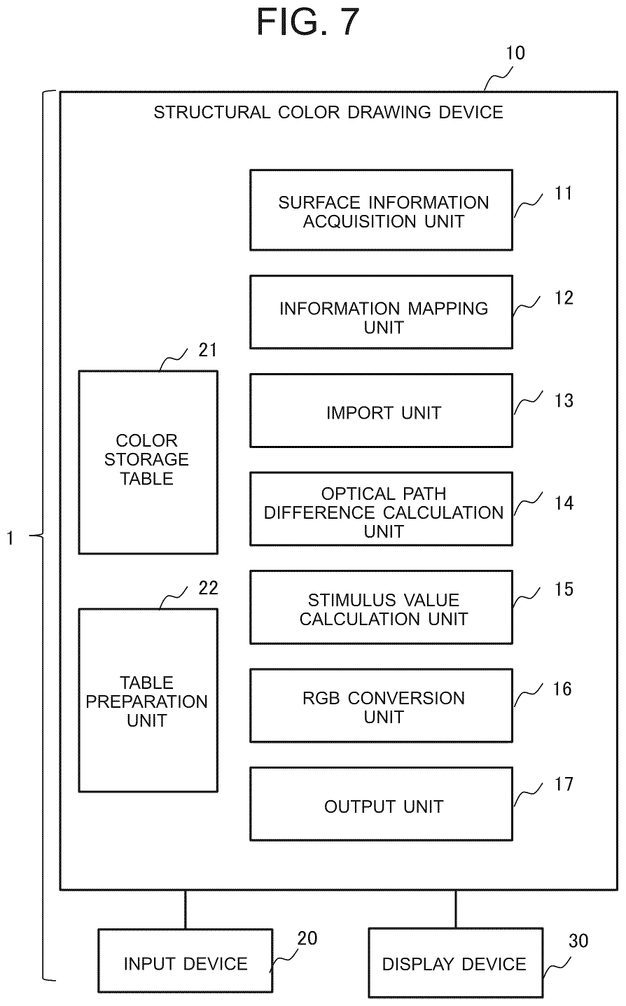

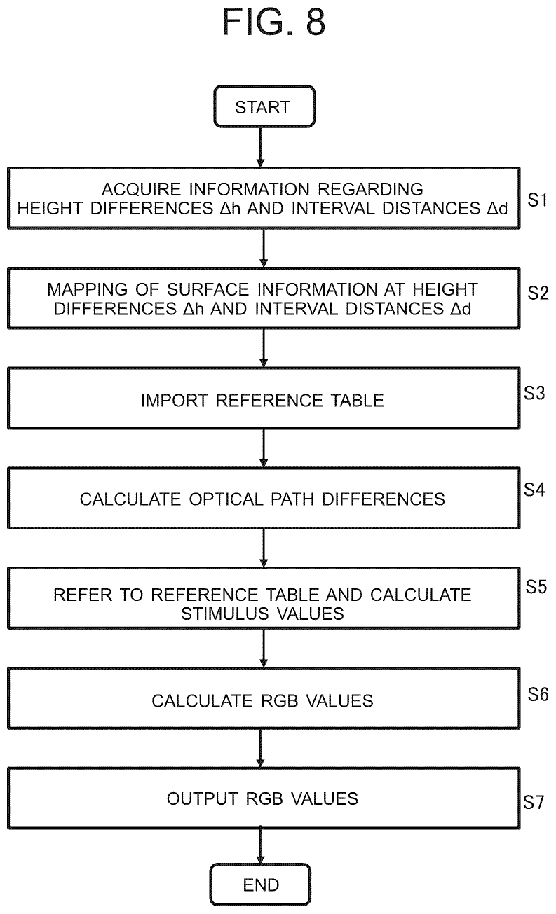

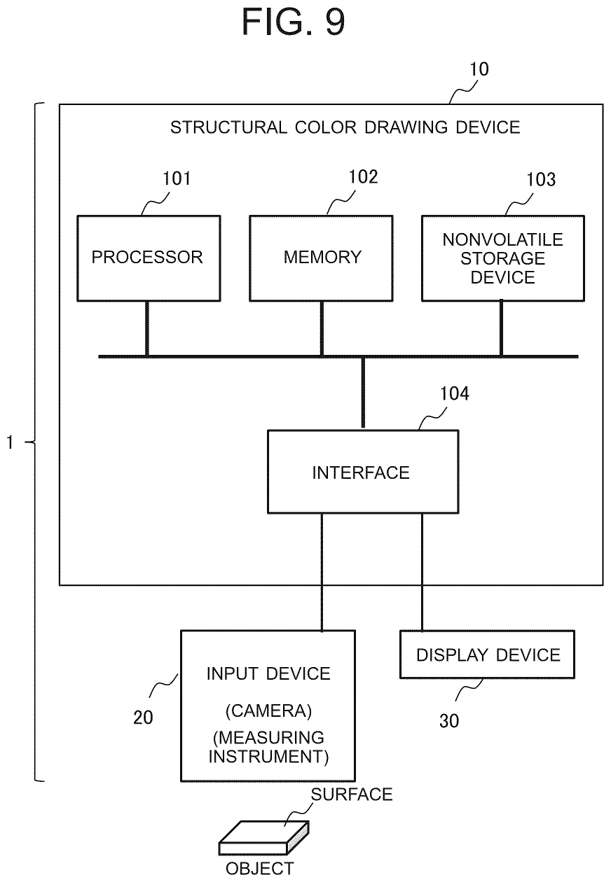

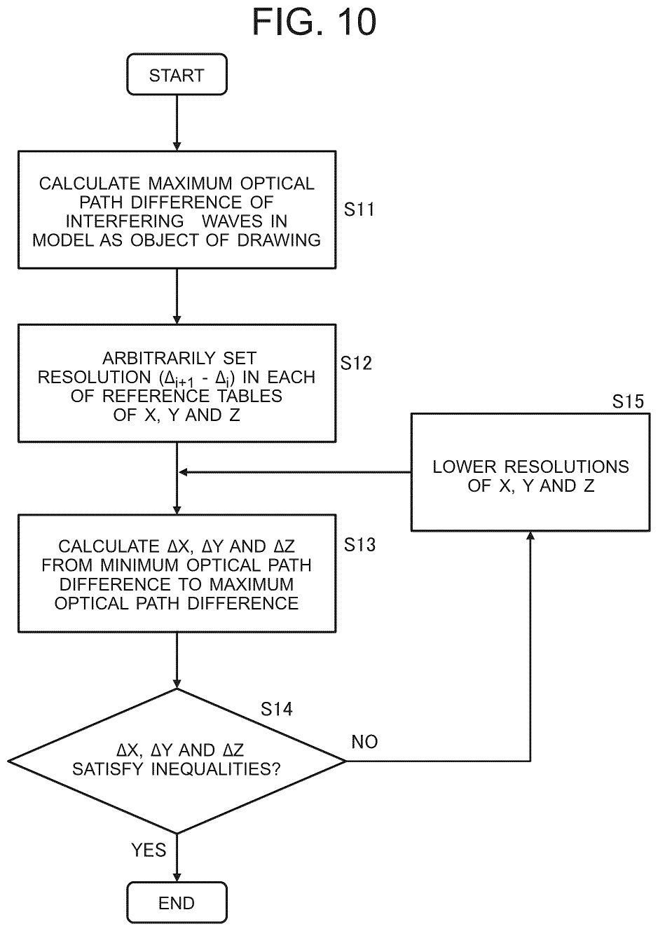

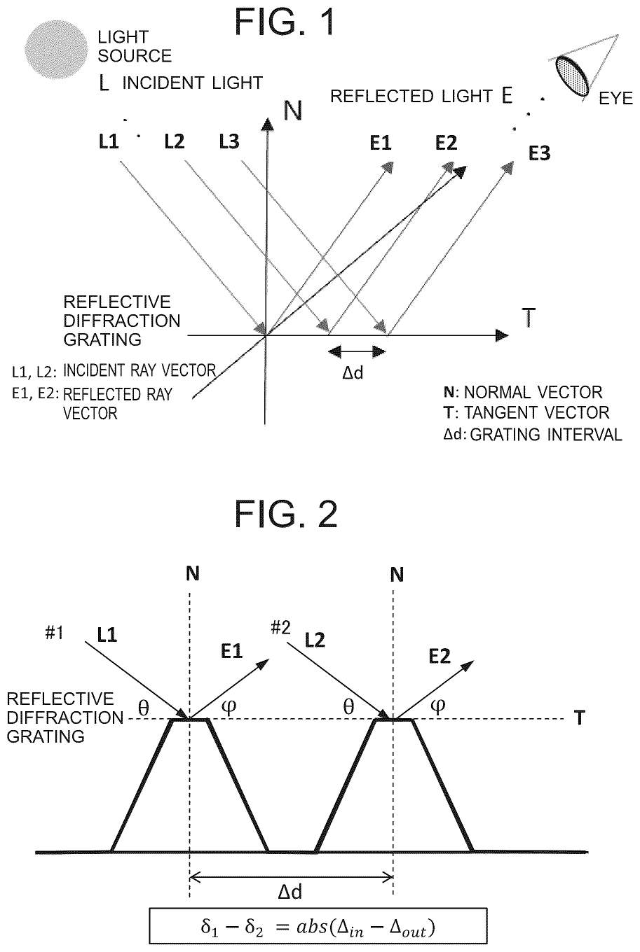

FIG. 1 is a diagram for explaining calculation of an optical path difference Δᵢₙ between incident rays on the reflective diffraction grating, an optical path difference bout between reflected rays reflected by the reflective diffraction grating, and a total optical path difference (δ₁−δ₂) as the sum total of the optical path difference between the incident rays and the optical path difference between the reflected rays. In FIG. 1, the reflective diffraction grating is arranged to extend in the direction of T as a tangent vector (transverse direction in FIG. 1). FIG. 2 is a schematic cross-sectional view magnifying the reflective diffraction grating in FIG. 1 (i.e., structure of the object in the comparative example).

In FIG. 1 and FIGS. 2, L1 and L2 represent incident ray vectors, and E1 and E2 represent reflected ray vectors. N represents a normal vector in a direction orthogonal to the tangent vector T. The Δd represents a grating interval, that is, the interval between adjacent peaks in the reflective diffraction grating. In FIG. 1 and FIG. 2, the total optical path difference (δ₁−δ₂) between a ray #1 represented by L1 and E1 and a ray #2 represented by L2 and E2 is represented by the following expression (6). Further, Δᵢₙ and Δₒᵤₜ are represented by expressions (7) and (8).

$${δ}_{1} - {δ}_{2} = abs ( {Δ}_{i n} - {Δ}_{out} ) . \qquad ( 6 )$$

$${Δ}_{i n} = Δ d ( L 1 \cdot T ) . \qquad ( 7 )$$

$${Δ}_{out} = Δ d ( E 1 \cdot T ) . \qquad ( 8 )$$

Here, Δᵢₙ represents the optical path difference between the two incident rays represented by the incident ray vectors L1 and L2, and Δₒᵤₜ represents the optical path difference between the two reflected rays represented by the reflected ray vectors E1 and E2. In the expression (7), (L1·T) represents the inner product of the incident ray vector L1 and the tangent vector T, and (E1·T) represents the inner product of the reflected ray vector E1 and the tangent vector T. By totalizing the optical path difference in the incident light and the optical path difference in the reflected light, the total optical path difference (δ₁−δ₂) between the ray #1 and the ray #2 can be obtained.

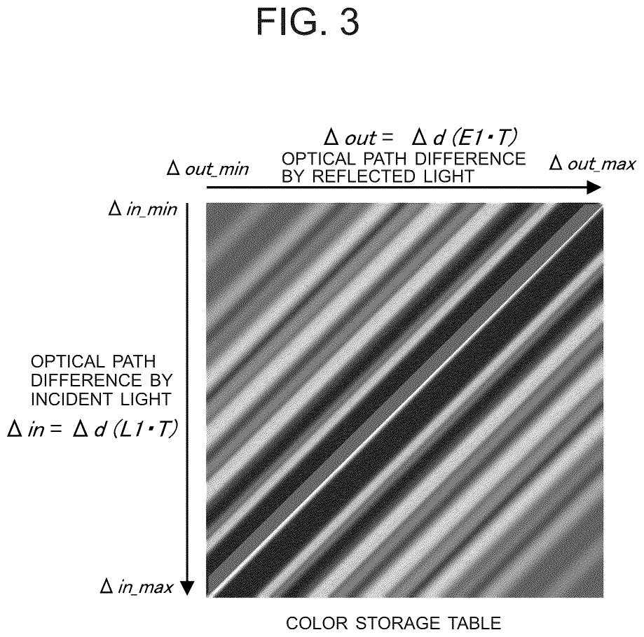

FIG. 3 is a diagram showing an example of a color structure texture as a color storage table. The color structure texture indicates a relationship between the optical path difference and the structural color. The color structure texture receives the incident light optical path difference Δᵢₙ and the reflected light optical path difference Δₒᵤₜ as inputs and outputs a corresponding color. The vertical axis of the color structure texture in FIG. 3 represents a range from a minimum optical path difference Δᵢₙ min as the minimum value of the incident light optical path difference Δᵢₙ to a maximum optical path difference Δᵢₙ max as the maximum value of the incident light optical path difference Δᵢₙ, and the horizontal axis of the color structure texture in FIG. 3 represents a range from a minimum optical path difference Δₒᵤₜ min to a maximum optical path difference Δₒᵤₜ max of the reflected light optical path difference Δₒᵤₜ. Colors in all combinations of a plurality of values between the minimum optical path difference Δᵢₙ min and the maximum optical path difference Δᵢₙ max of the incident light and a plurality of values between the minimum optical path difference Δₒᵤₜ min and the maximum optical path difference Δₒᵤₜ max of the reflected light are previously obtained by calculation, and the results of the calculation are stored in a storage device as the color storage table. That is, coloring information about coloring caused by the interference of waves, in regard to all the combinations of the plurality of optical path differences of the incident light and the plurality of optical path differences of the reflected light, has previously been stored in the storage device as the color storage table.

### (Structural Color Drawing Method According to Embodiment)

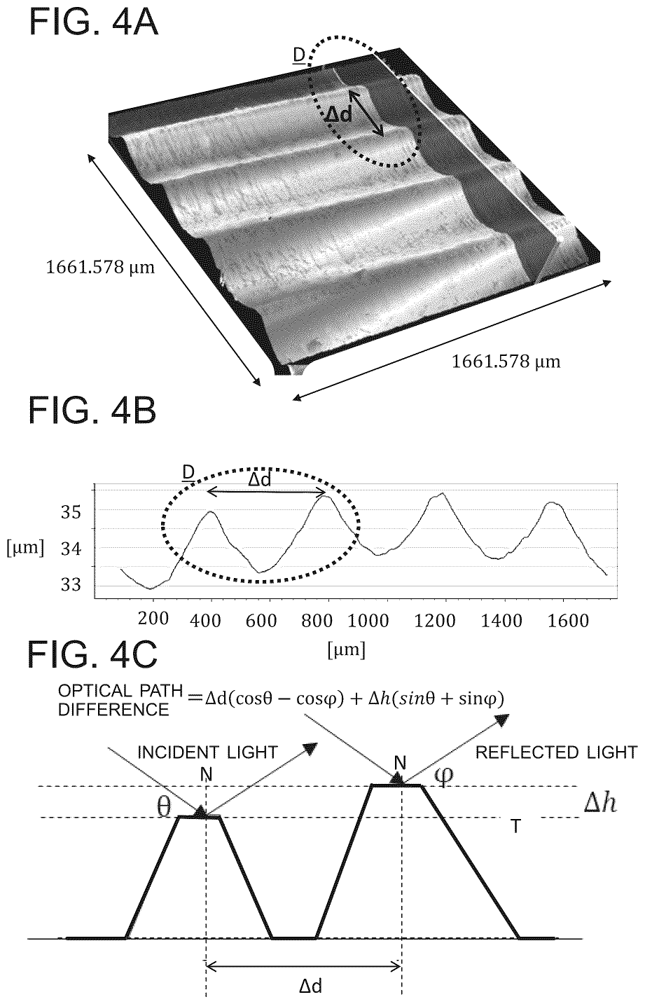

FIG. 4A is a schematic perspective view showing an example of the object as the target object of the drawing, FIG. 4B is a diagram showing a cross-sectional shape of the object in FIG. 4A, and FIG. 4C is a schematic diagram showing a cross section of a part D in FIGS. 4A and 4B. That is, FIGS. 4A to 4C show an example of the reflective diffraction grating as the microscopic structure appearing on a processing surface or the like of the object.

As shown in FIG. 2, in the comparative example, a model of the reflective diffraction grating, involving the incidence angle of the incident light heading for the microscopic structure on the surface of the object and the reflection angle of the reflected light heading for a viewpoint from the microscopic structure, is handled when calculating the optical path differences. In contrast, in this embodiment, as shown in FIGS. 4A to 4C, a model of a reflective diffraction grating, in which the incidence angle of the incident light heading for the microscopic structure on the surface of the object, the reflection angle of the reflected light heading for the viewpoint from the microscopic structure, and information other than the incidence angle and the reflection angle (i.e., height difference Δh as other information) are involved in the optical path differences, is handled when calculating the optical path differences. Ah represents the difference in the height between adjacent peaks in the diffraction grating. In the example of FIG. 4C, the optical path difference is represented by the following expression (9):

$$Optical Path Difference = Δ d ( cos θ - cos φ ) + Δ h ( sin θ + sin φ ) . \qquad ( 9 )$$

$$90 ° - θ : Incidence Angle , 90 ° - φ : Reflection Angle .$$

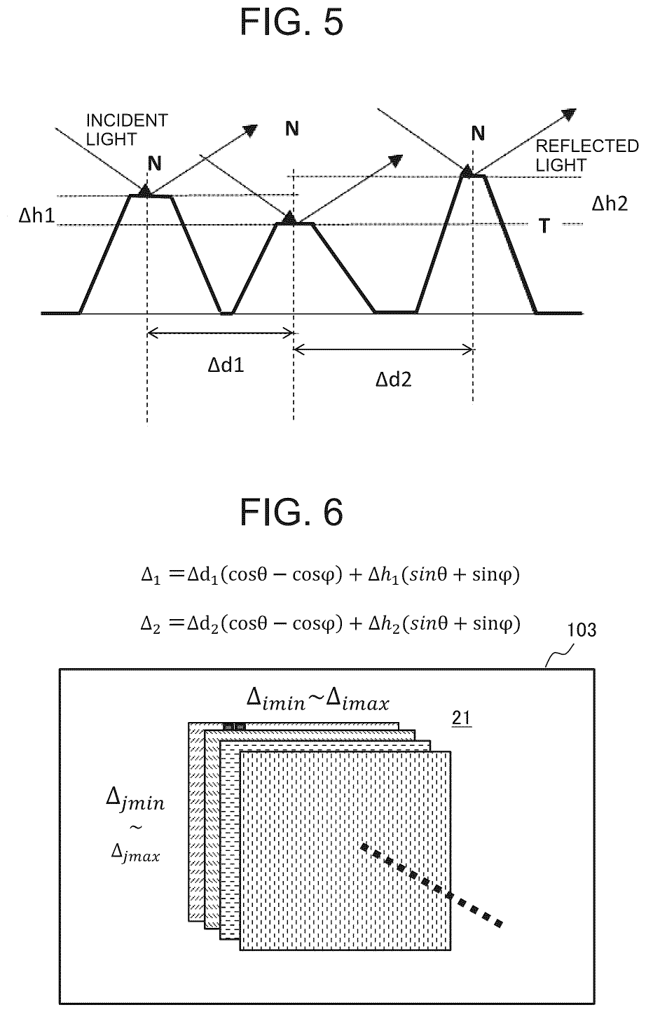

FIG. 5 is a schematic cross-sectional view magnifying the reflective diffraction grating on a surface of the object as the target object of the drawing. FIG. 5 shows a model of the reflective diffraction grating in which the incidence angle of the incident light heading for the microscopic structure on the surface of the object, the reflection angle of the reflected light heading for the viewpoint (i.e., eye) from the microscopic structure, and information other than the incidence angle and the reflection angle (i.e., other information) are involved when calculating the optical path differences. Δh1 represents the height difference between adjacent peaks (the peak at the center and the peak on the left side) of the diffraction grating, and Δh2 represents the height difference between adjacent peaks (the peak at the center and the peak on the right side) of the diffraction grating. Δd1 represents a grating interval, namely, an interval distance between adjacent peaks (the peak at the center and the peak on the left side) of the reflective diffraction grating. Δd2 represents a grating interval, namely, an interval distance between adjacent peaks (the peak at the center and the peak on the right side) of the reflective diffraction grating.

In the example of FIG. 5, the optical path difference is dependent on other information (peak height difference) in addition to the incidence angle and the reflection angle. That is, in the example of FIG. 5, depending on the position, the heights of adjacent peaks can differ from each other and there exists the optical path difference between adjacent waves, and thus the structural color cannot be reproduced accurately by the method described in the comparative example. With the method according to this embodiment, the optical path difference can be obtained accurately and the structural color drawing with high accuracy can be executed. Incidentally, the following description will be given of light hitting peaks of convex parts of the reflective diffraction grating, in which light incident upon concave parts of the reflective diffraction grating is considered to be scattered randomly in the concave parts and is assumed not to reach the viewpoint.

In general, in order to represent a model in which the optical path difference is dependent on a variable other than the incidence angle and the reflection angle (e.g., processing surface of an object that has been cut) by structural colors that develop, it is necessary to calculate the stimulus value X in the XYZ color model by using the following expression (10). Here, K represents a proportionality coefficient.

$$X = K {\int }_{380}^{780} R ( λ ) I ( λ ) x ( λ ) d λ . \qquad ( 10 )$$

$$K = \frac{100}{{\int }_{380}^{780} R ( λ ) y ( λ ) d λ} .$$

By substituting the intensity I(Δ) of the interference wave represented by the expression (4) into the expression (10), the following expression (11) is obtained. Further, the optical path differences in the expression (11) are represented by expressions (12) and (13).

$$X = K ( ( First Term ) + ( Second Term ) ) = K ( {\int }_{380}^{780} {\sum }_{i = 1}^{n} {A}_{i}^{2} R ( λ ) x ( λ ) d λ + {\sum }_{i = 1}^{n} {\sum }_{j = i + 1}^{n} {A}_{i} {A}_{j} {\int }_{380}^{780} cos ( \frac{2 π}{λ} {Δ}_{i} - \frac{2 π}{λ} {Δ}_{j} ) R ( λ ) x ( λ ) d λ ) . \qquad ( 11 )$$

$${Δ}_{i} = Δ {d}_{i} ( cos θ - cos φ ) - Δ {h}_{i} ( sin θ - sin φ ) . \qquad ( 12 )$$

$${Δ}_{j} = Δ {d}_{j} ( cos θ - cos φ ) - Δ {h}_{j} ( sin θ - sin φ ) . \qquad ( 13 )$$

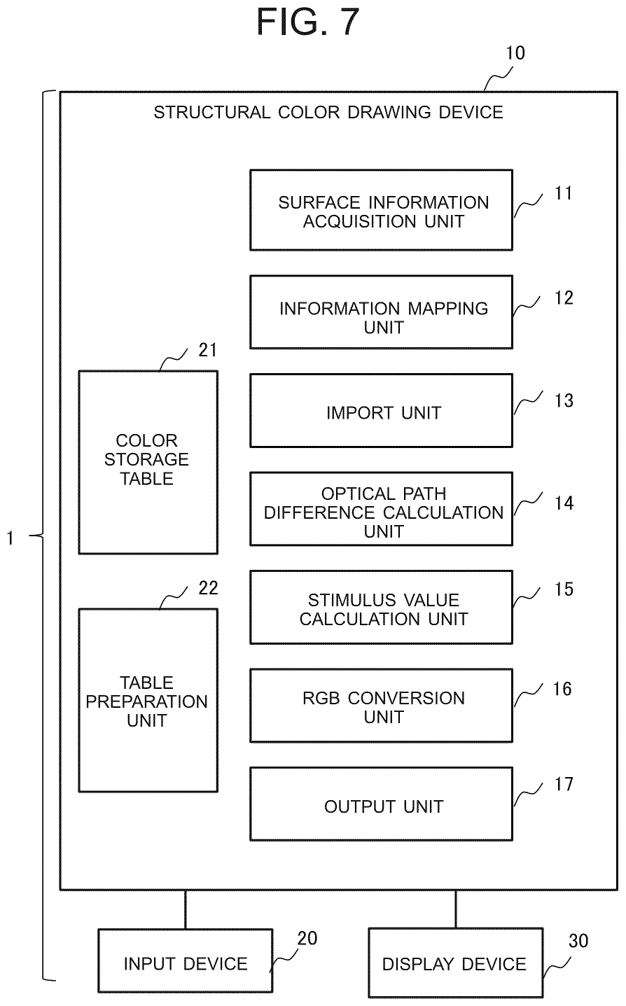

Also for the stimulus values Y and Z in the XYZ color model, calculation is executed similarly to the above-described calculation for the stimulus value X. Further, with the increase in the number of interfering waves, the number of integral calculations also increases. Since the number of calculations in the second term on the right side of the expression (11) is large, it is unrealistic to execute these calculations during simulation. While the first term of the calculation formula for calculating the color is independent of the optical path difference, the second term is dependent on the optical path difference. That is, only the second term on the right side of the expression (11) is dependent on the optical path differences Δᵢ and Δⱼ. Therefore, in regard to the following part in the second term on the right side, a conversion table (referred to also as a “reference table”) regarding all combinations of the optical path differences Δᵢ and Δⱼ (i.e., all combinations of i=1, 2, . . . , n and j=2, . . . , n+1) is previously prepared and stored in the storage device as the color storage table (21 in FIG. 6 and FIG. 7 which will be explained later). While the preparation of the color storage table is made by a table preparation unit (22 in FIG. 7), for example, the preparation of the color storage table may also be made by a device other than the structural color drawing device 10. Further, the color storage table may also be stored in another device (e.g., server computer on a network) different from the structural color drawing device 10.

$${\int }_{380}^{780} cos ( \frac{2 π}{λ} {Δ}_{i} - \frac{2 π}{λ} {Δ}_{j} ) R ( λ ) x ( λ ) d λ .$$

$${\int }_{380}^{780} cos ( \frac{2 π}{λ} {Δ}_{i} - \frac{2 π}{λ} {Δ}_{j} ) R ( λ ) y ( λ ) d λ .$$

$${\int }_{380}^{780} cos ( \frac{2 π}{λ} {Δ}_{i} - \frac{2 π}{λ} {Δ}_{j} ) R ( λ ) z ( λ ) d λ .$$

In other words, the expressions (12) and (13) are calculated in regard to all combinations of the optical path differences Δᵢ and Δⱼ, namely, all combinations of all optical path differences Δᵢ from Δᵢₘᵢₙ to Δᵢₘₐₓ and all optical path differences Δⱼ from Δⱼₘᵢₙ to Δⱼₘₐₓ, and the results of the calculation are stored as the color storage table. FIG. 6 is a diagram showing an example of the color storage table stored in a nonvolatile storage device 103.

In the preparation of the color storage table, influence of the height of the resolution on the RGB values has to be taken into consideration. Therefore, XYZ values not influencing integer parts of the RGB values will be considered below as a step. As explained earlier, the RGB values are calculated by using the expression (5).

$$[ \begin{matrix}R \\ G \\ B\end{matrix} ] = [ \begin{matrix}3.240479 & - 1.53715 & - 0.498535 \\ - 0.969256 & 1.875992 & 0.041556 \\ 0.055648 & - 0.204043 & 1.057311\end{matrix} ] [ \begin{matrix}X \\ Y \\ Z\end{matrix} ] . \qquad ( 5 )$$

In cases where values are rounded off to the nearest integers in the derivation of the RGB values, the integer parts of the RGB values are not influenced if a combination of X, Y and Z satisfying the following inequalities (14), (15) and (16) is selected.

$$3.240479 X - 1.537150 Y - 0.498535 Z < 0.5 ( R ) . \qquad ( 14 )$$

$$- 0.9 \; 69256 X + 1.875992 Y + 0.041556 Z < 0.5 ( G ) . \qquad ( 15 )$$

$$0.05 5648 X - 0.204043 Y + 1.057311 Z < 0.5 ( B ) . \qquad ( 16 )$$

However, in cases where digits after the decimal point are ignored in the derivation of the RGB values, “0.5” on the right sides of the expressions (14) to (16) is replaced with “1”. That is, in order to eliminate the influence of the height of the resolution on the RGB values, XYZ differences calculated from the optical path differences Δₛ₊₁, Δₛ, Δₜ₊₁, Δₜ, Δᵤ₊₁ and Au at a certain resolution need to satisfy all of the aforementioned expressions (14) to (16).

The resolutions ΔX=Δₛ₊₁−Δₛ, ΔY=Δₜ₊₁−Δₜ and ΔZ=Δᵤ₊₁−Δᵤ of X, Y and Z are set arbitrarily, and are calculated from the minimum optical path difference Δₘᵢₙ to Δₘₐₓ according to the following expressions (17) to (19). Incidentally, n represents the number of interfering waves.

$$Δ X = \frac{n ( n - 1 )}{2} ( {\int }_{380}^{780} cos ( \frac{2 π}{λ} {Δ}_{s} ) R ( λ ) x ( λ ) d λ - {\int }_{380}^{780} cos ( \frac{2 π}{λ} {Δ}_{s + 1} ) R ( λ ) x ( λ ) d λ ) . \qquad ( 17 )$$

$$Δ Y = \frac{n ( n - 1 )}{2} ( {\int }_{380}^{780} cos ( \frac{2 π}{λ} {Δ}_{t} ) R ( λ ) y ( λ ) d λ - {\int }_{380}^{780} cos ( \frac{2 π}{λ} {Δ}_{t + 1} ) R ( λ ) y ( λ ) d λ ) . \qquad ( 18 )$$

$$Δ Z = \frac{n ( n - 1 )}{2} ( {\int }_{380}^{780} cos ( \frac{2 π}{λ} {Δ}_{u} ) R ( λ ) z ( λ ) d λ - {\int }_{380}^{780} cos ( \frac{2 π}{λ} {Δ}_{u + 1} ) R ( λ ) z ( λ ) d λ ) . \qquad ( 19 )$$

When one or more of the following expressions (20) to (22) regarding ΔX, ΔY and ΔZ are not satisfied, the resolutions of X, Y and Z are lowered and the calculation is executed again. When all of the expressions (20) to (22) regarding ΔX, ΔY and ΔZ are satisfied, the height of the resolution has no influence on the RGB values, and thus the values of the resolutions of X, Y and Z at that time point can be used.

$$abs ( 3. 2404 \; 79 Δ X - 1.5371 \; 50 Δ Y - 0.4985 \; 35 Δ Z ) < 0.5 . \qquad ( 20 )$$

$$abs ( - 0.9692 \; 56 Δ X + 1.8759 \; 92 Δ Y + 0.0415 \; 56 Δ Z ) < 0.5 . \qquad ( 21 )$$

$$abs ( 0.0556 \; 48 Δ X - 0.2040 \; 43 Δ Y + 1.0573 \; 11 Δ Z ) < 0.5 . \qquad ( 22 )$$

### (Structural Color Drawing Device According to Embodiment)

FIG. 7 is a functional block diagram showing the configuration of the structural color drawing device 10 and the structural color drawing system 1 according to the embodiment. The structural color drawing device 10 is a device that reproduces the structural color of an object, including a surface information acquisition unit 11, an information mapping unit 12, an optical path difference calculation unit 14, an import unit 13, a stimulus value calculation unit 15, an RGB conversion unit 16 and an output unit 17.

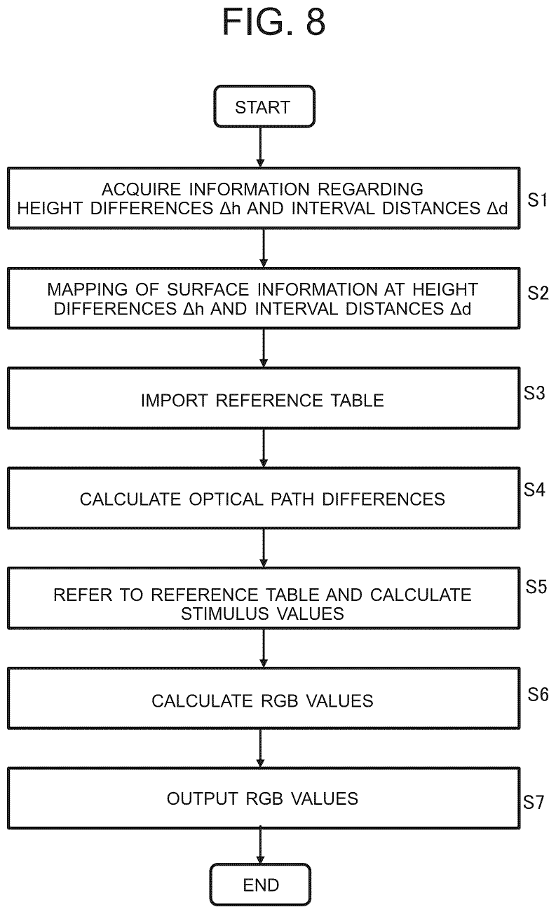

FIG. 8 is a flowchart showing a drawing operation executed by the structural color drawing device 10. The surface information acquisition unit 11 acquires the surface information including the height differences of a plurality of peaks in the uneven structure on the surface of the object (Δh1, Δh2 in FIG. 5) and the interval distances between adjacent peaks among the plurality of peaks (Δd1, Δd2 in FIG. 5) from a captured image obtained by the camera or the measurement information obtained by the measuring instrument (step S1).

The information mapping unit 12 maps the surface information acquired by the surface information acquisition unit 11 on a drawing object corresponding to the object.

The import unit 13 imports the reference table storing values of the second term of the expression (11), as the calculation formula of the stimulus value in the XYZ color model having the first term independent of the optical path difference and the second term dependent on the optical path difference, while associating the values with the optical path differences (Δᵢₘᵢₙ−Δᵢₘₐₓ, Δⱼₘᵢₙ−Δⱼₘₐₓ) (step S3).

The optical path difference calculation unit 14 calculates the optical path differences Δᵢ and Δⱼ at each position on the drawing object according to the aforementioned expressions (12) and (13) by using the mapped surface information and outputs optical path difference calculation values (step S4).

The stimulus value calculation unit 15 acquires values corresponding to the optical path difference calculation values from the imported reference table and calculates the three stimulus values in the XYZ color model by using the expression (11) as the calculation formula and the values of the second term on the right side of the expression (11) (step S5).

The RGB conversion unit 16 converts the three stimulus values to the RGB values by using the aforementioned expression (5) (step S6). The output unit 17 outputs the RGB values to the display device 30 (step S7).

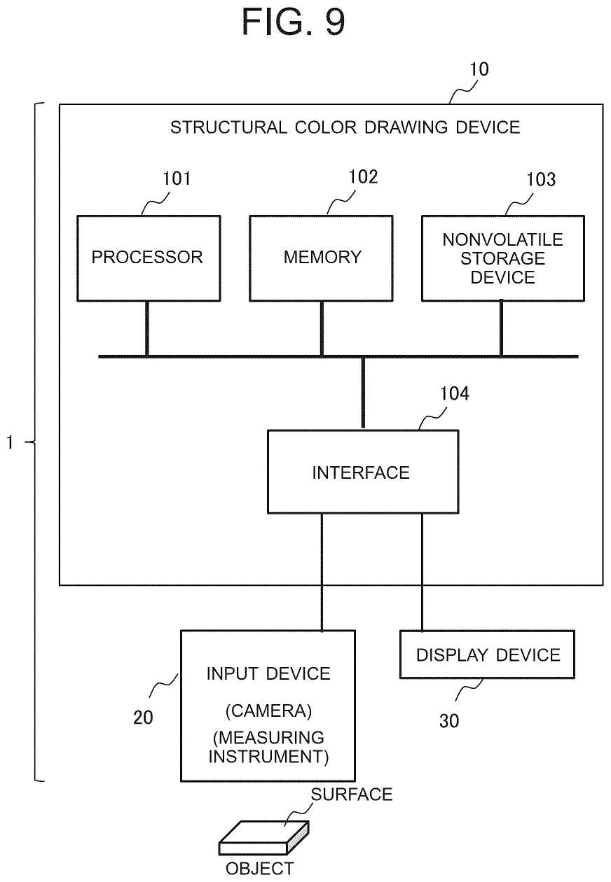

FIG. 9 is a diagram showing an example of the hardware configuration of the structural color drawing device 10 and the structural color drawing system 1 according to the embodiment. The structural color drawing device 10 is a computer, for example. The structural color drawing device 10 is a device capable of executing the structural color drawing method according to the embodiment. The structural color drawing device 10 includes a processor 101 and a memory 102 as a volatile storage device. The structural color drawing device 10 may include the nonvolatile storage device 103 such as a hard disk drive (HDD) or a solid state drive (SSD) and an interface 104 for executing communication with external devices. The memory 102 is, for example, a semiconductor memory such as a RAM (Random Access Memory). The functions shown in FIG. 7 are formed by the processor that executes the structural color drawing program as a software program installed from a record medium or via a communication line and stored in the memory 102 as a storage medium or a record medium. The storage medium is a non-transitory computer-readable storage medium storing a program such as the structural color drawing program.

The functions of the structural color drawing device 10 may be implemented by a processing circuit. The processing circuit can be either dedicated hardware or the processor 101 that executes the structural color drawing program stored in the memory 102. The processor 101 can be any one of a processing device, an arithmetic device, a microprocessor, a microcomputer and a DSP (Digital Signal Processor).

In the case where the processing circuit is dedicated hardware, the processing circuit is an ASIC (Application Specific Integrated Circuit), an FPGA (Field Programmable Gate Array) or the like, for example.

Incidentally, it is also possible to implement part of the structural color drawing device 10 by dedicated hardware and other part by software or firmware. As above, the processing circuit is capable of implementing the above-described functions by hardware, software, firmware or a combination of some of these means.

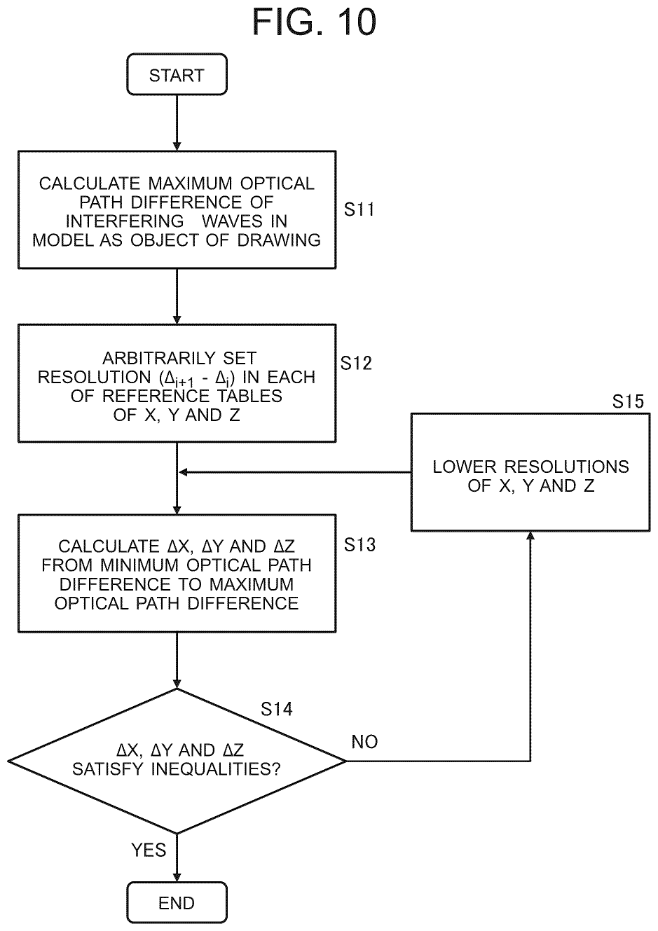

FIG. 10 is a flowchart showing a resolution determination process in the structural color drawing device 10. For example, in the preparation of the color storage table (reference table) 21, the table preparation unit 22 may determine the resolution according to the following procedure. First, the table preparation unit 22 calculates the maximum optical path difference of the interfering waves in the model as the object of the drawing (step S11). Subsequently, the table preparation unit 22 arbitrarily sets the resolution (Δᵢ₊₁−Δᵢ) in each of the reference tables of X, Y and Z (step S12). Subsequently, the table preparation unit 22 calculates ΔX, ΔY and ΔZ from the minimum optical path difference to the maximum optical path difference (step S13). Subsequently, the table preparation unit 22 judges whether or not ΔX, ΔY and ΔZ satisfy all of the inequalities (e.g., the expressions (14) to (16)) (step S14). Here, if all of the inequalities are satisfied (YES in the step S14), the table preparation unit 22 ends the resolution determination process. If there is an inequality not satisfied (NO in the step S14), the table preparation unit 22 lowers the resolutions of X, Y and Z and returns the process to the step S13.

### (Effect of Embodiment)

According to the embodiment, by utilizing roughness (height) and interval distance information at each position for the calculation of the optical path difference at each position, the calculation of the color values is made possible and the structural color can be drawn.

Further, the term dependent on the optical path difference in the color value calculation formula is tabularized into the reference table, by which the color value calculation is made realistic and real-time displaying of the structural color is made possible.

Further, in the preparation of the reference table, the influence of the height of the resolution on the calculated RGB values can be eliminated.

### DESCRIPTION OF REFERENCE CHARACTERS

1: structural color drawing system, 10: structural color drawing device, 11: surface information acquisition unit, 12: information mapping unit, 14: optical path difference calculation unit, 13: import unit, 15: stimulus value calculation unit, 16: RGB conversion unit, 17: output unit, 20: input device, 30: display device.

What is claimed is:

1. A structural color drawing device that reproduces structural color of an object, comprising processing circuitry
to acquire surface information, including height differences of a plurality of peaks in uneven structure on a surface of the object and interval distances between adjacent peaks among the plurality of peaks, from a captured image obtained by a camera or measurement information obtained by a measuring instrument;
to map the surface information on a drawing object corresponding to the object;
to calculate an optical path difference at each position on the drawing object by using the mapped surface information and to output optical path difference calculation values;
to import a reference table storing values of a second term of a calculation formula of a stimulus value in an XYZ color model having a first term independent of the optical path difference and the second term dependent on the optical path difference while associating the values with the optical path differences;
to acquire values corresponding to the optical path difference calculation values from the imported reference table and to calculate three stimulus values in the XYZ color model by using the calculation formula and the values; and
to convert the three stimulus values to RGB values.

2. The structural color drawing device according to claim 1, wherein the processing circuitry calculates the optical path difference calculation values according to a following calculation formula:
$$Optical Path Difference Calculation Value = Δ d ( cos θ - cos φ ) + Δ h ( sin θ + sin φ ) ,$$
$$90 ° - θ : Incidence Angle , 90 ° - φ : Reflection Angle ,$$
$$Δ h : Peak Height Difference , Δ d : Peak Interval Distance .$$

3. The structural color drawing device according to claim 1, wherein
the first term is a term based on spectral distribution of a light source that applies light to the object and a color matching function in the XYZ color model, and
the second term is a term based on the spectral distribution, the color matching function and the optical path difference calculation values.

4. The structural color drawing device according to claim 3, wherein
the second term is represented by following expressions:
$${\int }_{380}^{780} cos ( \frac{2 π}{λ} {Δ}_{i} - \frac{2 π}{λ} {Δ}_{j} ) R ( λ ) x ( λ ) d λ ,$$
$${\int }_{380}^{780} cos ( \frac{2 π}{λ} {Δ}_{i} - \frac{2 π}{λ} {Δ}_{j} ) R ( λ ) y ( λ ) d λ ,$$
$${\int }_{380}^{780} cos ( \frac{2 π}{λ} {Δ}_{i} - \frac{2 π}{λ} {Δ}_{j} ) R ( λ ) z ( λ ) d λ ,$$
and the optical path difference calculation values are calculated according to following expressions:
$${Δ}_{i} = Δ {d}_{i} ( cos θ - cos φ ) + Δ {h}_{i} ( sin θ + sin φ ) ,$$
$${Δ}_{j} = Δ {d}_{j} ( cos θ - cos φ ) + Δ {h}_{j} ( sin θ + sin φ ) ,$$
where
R(λ) represents the spectral distribution,
λ represents a wavelength of the light,
x(λ), y(λ) and z(λ) represent the color matching functions,
i represents a positive integer, and
j=i+1.

5. A structural color drawing system comprising:
the structural color drawing device according to claim 1;
an input device including the camera or the measuring instrument; and
a display device to display an image based on the RGB values.

6. A structural color drawing method to be executed by a structural color drawing device that reproduces structural color of an object, comprising:
acquiring surface information, including height differences of a plurality of peaks in uneven structure on a surface of the object and interval distances between adjacent peaks among the plurality of peaks, from a captured image obtained by a camera or measurement information obtained by a measuring instrument;
mapping the surface information on a drawing object corresponding to the object;
calculating an optical path difference at each position on the drawing object by using the mapped surface information and outputting optical path difference calculation values;
importing a reference table storing values of a second term of a calculation formula of a stimulus value in an XYZ color model having a first term independent of the optical path difference and the second term dependent on the optical path difference while associating the values with the optical path differences;
acquiring values corresponding to the optical path difference calculation values from the imported reference table and calculating three stimulus values in the XYZ color model by using the calculation formula and the values; and
converting the three stimulus values to RGB values.

7. A non-transitory computer-readable storage medium storing a structural color drawing program that causes a computer reproducing structural color of an object to execute:
acquiring surface information, including height differences of a plurality of peaks in uneven structure on a surface of the object and interval distances between adjacent peaks among the plurality of peaks, from a captured image obtained by a camera or measurement information obtained by a measuring instrument;
mapping the surface information on a drawing object corresponding to the object;
calculating an optical path difference at each position on the drawing object by using the mapped surface information and outputting optical path difference calculation values;
importing a reference table storing values of a second term of a calculation formula of a stimulus value in an XYZ color model having a first term independent of the optical path difference and the second term dependent on the optical path difference while associating the values with the optical path differences;
acquiring values corresponding to the optical path difference calculation values from the imported reference table and calculating three stimulus values in the XYZ color model by using the calculation formula and the values; and
converting the three stimulus values to RGB values.
